(19) United States
(12) Patent Application Publication
(10) Pub. No.: US 2002/0150210 A1
(43) Pub. Date: Oct. 17, 2002

(54) Method, X-ray device and computer program for enhancing the image quality of images of the cardiovascular system of a patient

(76) Inventor: Herman Stegehuis, Eindhoven (NL)

Correspondence Address: THOMAS M. LUNDIN, Philips Medical Systems (Cleveland), Inc., 595 Miner Road, Cleveland, OH, 44143, US

(21) Appl. No.: 10/121,250

(22) Filed: Apr. 12, 2002

(30) Foreign Application Priority Data
Apr. 13, 2001 (EP) 01201353.8

(51) Int. Cl. H05G 1/10

(52) U.S. Cl. 378/95

(57) ABSTRACT

The invention relates to a method, a device and a program for enhancing the image quality of images of the cardiovascular system of a patient which are produced by means of an X-ray device which includes a pulse generator for producing successive images at a given rate.

The method includes the steps of:

a) measuring the activity of the heart of the patient,

b) controlling the pulse generator on the basis of the heart activity, and also the steps of:

c) adjusting the desired number of images per heart beat,

d) calculating an instant for issuing a pulse on the basis of the heart activity as measured in the step a) and the number of images per heart beat as adjusted in the step c),

e) determining the amount of the X-ray dose per pulse, and

f) controlling the generator on the basis of the pulse issue instant as calculated in the step d) and the amount of the X-ray dose as determined in the step e).

### BACKGROUND

The invention relates to a method of enhancing the image quality of images of the cardiovascular system of a living being, which images are formed by means of an X-ray device which includes a generator for issuing pulses at a given rate in order to form successive images, which method includes the following steps:

a) measuring the activity of the heart of the patient, and

b) controlling the generator on the basis of the heart activity.

A previous method is described in the article “Adaptive pulse rate scheduling for reduced dose X-ray cardiac interventional fluoroscopic procedures”, Malek et al, published in Proceedings Fifth Annual IEEE Symposium on Computer-based Medical Systems, Jun. 14-17, 1992, Durham (N.C.).

The method relates to medical interventional procedures in the cardiovascular system of a patient in which images of the patient are formed during the intervention by means of an X-ray fluoroscopy device. The number and the complexity of such interventions become higher still every year, so that patients and medical staff are exposed to X-rays to an ever greater extent. When the maximum permissible annual dose is observed, the number of such interventional procedures that can be performed per annum by medically schooled personnel is limited. Therefore, from practice a demand is heard for a method of reducing the X-ray dose applied during such medical interventional procedures. However, reducing the X-ray dose has an adverse effect on the image quality.

Another problem is posed by the fact that the cardiovascular system of the patient moves along with the motions of the heart during the formation of the images. Major changes occur in the volumes of the chambers and atria of the heart notably during the contractions and relaxations of the myocardium in each cardiac cycle, and large volumes of blood are also displaced by the arteries. The associated motions necessitate a high image rate, that is, the use of a large number of pulses per second so as to form the images necessary to realize a smooth rendition of these motions.

In conformity with the known method the pulse rate of the generator is adapted to the motion of the myocardium during the cardiac cycle of the patient. In the presence of contractions and relaxations of the myocardium the pulse rate is higher than in periods in which the motion of the myocardium is comparatively weak. The total number of pulses issued per intervention is thus reduced. For the same X-ray dose per pulse, this results in a reduction of the total amount of X-rays applied per intervention.

For some time already it has been common practice to introduce foreign objects into the human body. An example in this respect, relating to the described medical interventional procedures in the cardiovascular system, is the introduction of a so-called stent into an artery, usually to reinforce the wall after dilation, for example, after percutaneous angioplasty.

In order to check the correct positioning of such a foreign body, it is necessary to form an image thereof by means of the method mentioned in the preamble. As has already been stated, the movement of the relevant artery as part of the cardiovascular system impedes the imaging. A further complication encountered in the formation of an image consists in the tendency to select ever thinner materials for the foreign body, so that it becomes more difficult to perform imaging by means of X-rays.

It will be evident that this problem cannot be solved in an acceptable manner by increasing the X-ray dose; granted, such an increase would yield an enhanced image quality, but would go directly against the above-mentioned object of achieving a dose reduction.

### SUMMARY

It is an object of the invention to provide a method of the kind set forth which solves the described problems.

To this end, the method in accordance with the invention is characterized in that it also comprises the following steps:

c) adjusting the desired number of images per heart beat;

d) calculating an instant for issuing a pulse on the basis of the heart activity as measured in the step a) and the number of images per heart beat as adjusted in the step c);

e) determining the amount of the X-ray dose per pulse, and

f) controlling the generator on the basis of the pulse issue instant as calculated in the step d) and the amount of the X-ray dose as determined in the step e).

The method in accordance with the invention enables adjustment of both the number of pulses per heart beat and the value of the X-ray dose per pulse, thus enabling the formation of images of significantly enhanced image quality by means of an X-ray device. Foreign bodies can thus be imaged clearly in a safe manner.

In accordance with a first preferred version of the method according to the invention the desired number of images is adjusted to a few images per heart beat in the step c), that is, preferably to one image per heart beat. The number of images per unit of time is preferably chosen to be as small as possible, so that the associated amount of applied X-rays is as small as possible.

In conformity with a further preferred version, the instant for issuing an X-ray pulse as calculated in the step d) lies in the end-diastolic phase of the heartbeat. The myocardium and all parts of the human body that move together with the myocardium exhibit the least motion in this phase, so that an image of adequate quality can be obtained by means of one image per heart beat.

In accordance with a further preferred version the value of the X-ray dose per pulse as determined in the step e) is inversely proportional to the number of images per heart beat as adjusted in the step c). Evidently, any legally permissible maximum values in respect of the dose must then be observed for each pulse. Tuning the two parameters to one another in this manner enables enhancement of the image quality of X-ray images while the total applied X-ray dose can remain the same or can even be reduced in comparison with the known method.

The present invention also relates to an X-ray device for carrying out the method in accordance with the invention, which device includes an X-ray source, a generator which communicates with the X-ray source so as to issue pulses at a given rate for the formation of successive images, an X-ray detector and a control unit for controlling the generator, which device also includes:

a) measuring means for measuring the activity of the heart of the patient;

b) adjusting means for adjusting the desired number of images per heart beat;

c) arithmetic means for calculating an instant for issuing a pulse on the basis of the heart activity as measured in the step a) and the number of images per heart beat as adjusted in the step b);

d) means for determining the amount of the X-ray dose per pulse, and

e) means for controlling the generator on the basis of the pulse issue instant as determined in the step c) and the amount of the X-ray dose as determined in the step d).

The invention also relates to a computer program for carrying out the method in accordance with the invention.

### DRAWINGS

The invention will be described in detail hereinafter with reference to the drawings; therein:

FIG. 1 is a diagrammatic representation of an X-ray examination apparatus 1 in accordance with the invention, and FIG. 2 shows an example of an electrocardiogram of a patient.

### DESCRIPTION

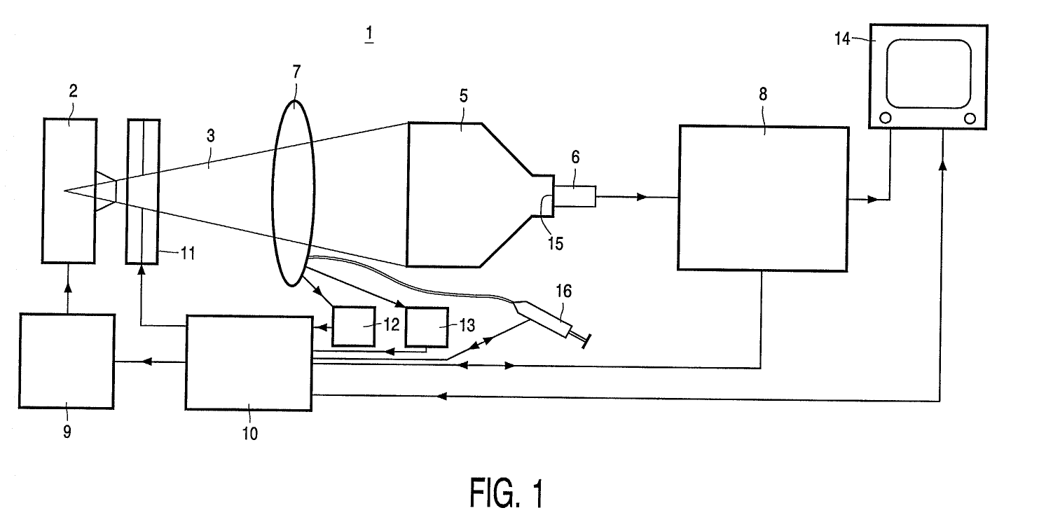

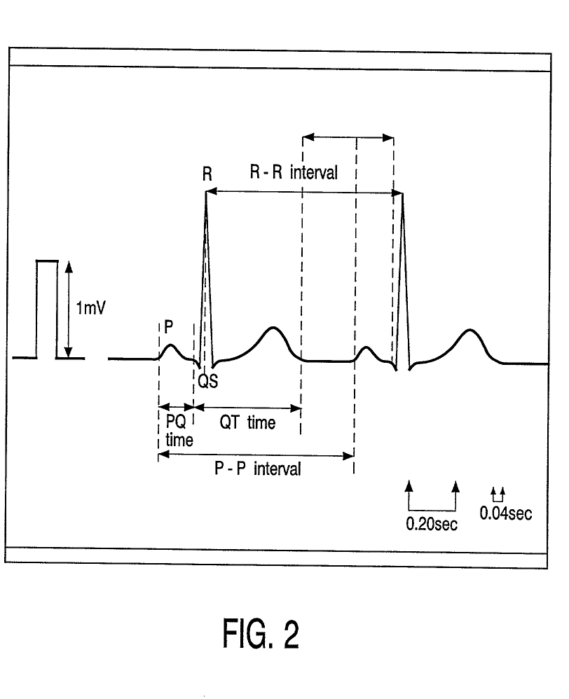

FIG. 1 is a diagrammatic representation of an X-ray examination apparatus 1 for medical diagnostic applications, for example, fluoroscopy or angiography. An X-ray source 2 generates a beam of X-rays 3 which emanates from a focus and is incident on an X-ray detector 5. The intensity of the X-ray beam is locally modulated due to differences of absorption in a living being, usually a patient 7, so that a projection image of the patient 7 appears on an entrance screen 4 of the X-ray detector 5. A reduced and brightness intensified image of the entrance screen 4 of the X-ray image intensifier 5 appears on the exit screen 15. The light image is converted, via a television camera tube 6 which cooperates with the exit screen of the X-ray image intensifier 5, into an electric signal which is applied to an image processing unit 8. It is to be noted that other types of detector which are known in this technical field can be used for dynamic imaging instead of the above X-ray detection chain.

The signals originating from the television camera tube 6 are digitized in the image processing unit 8 so as to be stored as a matrix of grey values for display on the image display unit 14, for example, a monitor. The device 1 also includes a pulse generator 9 which communicates with the X-ray source 2 so as to issue pulses at a given rate for the formation of successive images of the patient 7.

In practice the X-ray device 1 usually has two possibilities for adjustment, that is, a fluoroscopy mode and an exposure mode. In the fluoroscopy mode the number of images per second is comparatively high (for example, 30 images per second) and each image is formed while using a comparatively small X-ray dose (for example, approximately 30 nGray per image). In the exposure mode the number of images per second is smaller (for example, 15 images per second) and the X-ray dose per image is higher (for example, approximately 70 nGray per image). It is to be noted that said values are given merely by way of example. The actual values are dependent on various parameters such as, for example, the dimensions of the active detector surface.

A control unit 10 controls the generator and the image processing unit 8. The image processing unit may be arranged to execute operations which are optimally adapted to the described acquisition mode in order to enhance the contrast and signal-to-noise ratio of relevant details in the image. Some examples of image processing techniques which are known per se are, for example, temporal integration of successive images, specifically adapted spatial operations, and combination with images from previous image sequences or with previous images of the same sequence.

The control unit 10 also controls absorption means 11 which are arranged between the X-ray source 2 and the patient 7 in order to limit the X-ray beam 3. The absorption means 11 may include filter means and/or collimator means.

The control unit 10 also includes hardware and software so as to carry out these functions.

The foregoing is a general description of an X-ray device in which the present invention can be used. In this technical field various embodiments of such an X-ray device are known, so that this description will be sufficiently clear to a person skilled in the art.

In the context of the present invention the X-ray device 1 includes measuring means for measuring the activity of the heart of the patient. The measuring means in the preferred embodiment shown include ECG recording equipment 12 for measuring the myocardiac activity of the patient 7 during a cardiac cycle. FIG. 2 shows an example of a cardiogram of a patient which will be described in detail hereinafter. The measuring means 12 are connected to the control unit 10 and influence the control of the generator 9. In the context of the invention the control unit 10 also includes adjusting means for adjusting the desired number of images per heartbeat. Preferably, the adjusting means are arranged for adjustment to a few images per heartbeat. Most preferably the adjustment chosen is one image per heartbeat. In practice this will mean that a third mode in accordance with the invention is added to the above fluoroscopy and acquisition modes. The user can select the desired mode by pressing the associated button on a control panel (not shown). This choice defines the number of pulses issued by the generator 9 during each cardiac cycle.

The adjustment of the number of images per heartbeat is also dependent on the instant in the cardiac cycle at which the images are to be formed. To this end, the control unit 10 is provided with arithmetic means for calculating an instant for issuing a pulse. This calculation is performed on the basis of the heart activity measured by means of the ECG recording equipment 12 and on the basis of the number of images per heartbeat as adjusted by the user.

For the purpose of illustration, the arithmetic means may be arranged to calculate a given time delay for the pulse relative to a given, fixed point in the electrocardiogram. FIG. 2 is a diagrammatic representation of an example of a cardiogram of a human being. The known QRS peak can serve as the fixed starting point for the time delay to be calculated for the issue of pulses. In the present preferred embodiment images are made preferably in the so-called end-diastolic phase of a cardiac cycle. This is the phase in which the motion of the heart is comparatively slight, so that a sharper image can be obtained. The QT time as indicated in FIG. 2 or a percentage of the preceding R-R interval can be used as a measure for the time delay required for this purpose. The number of pulses per cardiac cycle can be reduced to, for example, a handful, the pulse rate being dependent on the degree of motion of the myocardium in the various phases of the cardiac cycle. It is to be expected that one exposure per cardiac cycle suffices if the exposure takes place in said end-diastolic phase.

The control unit 10 also includes means for determining the value of the X-ray dose per pulse. The image quality can be further enhanced by increasing the X-ray dose per pulse. Preferably, the means for determining the X-ray dose value per pulse are arranged to distribute a given permissible total X-ray dose during the intervention among the number of pulses during the intervention.

The control unit 10 controls the generator 9 on the basis of the pulse issue instant and the amount of the X-ray dose determined. A handful of images per heartbeat suffices, that is, in dependence on the instant in the cardiac cycle at which the images are formed. When the pulse issue instant lies in the end-diastolic phase, it probably suffices to form only one image per heartbeat. The X-ray dose can then be readily increased, for example, by a factor of 10, the total amount of applied X-rays nevertheless being reduced by a factor of from 2 to 3. An acceptable image display rate of, for example, 60 or more frames per second can be ensured by using so-called “frame filling” techniques which are well known in this technical field.

It is to be noted that the control unit 10 is also capable of controlling an injector 16 for a contrast medium in order to inject contrast medium, via a catheter, into an artery or vein to be examined. The artery (vein) thus becomes visible and its shape can be compared with previous images in which, for example, a stenosis or a stent is visible. The results of an intervention can be made very clearly visible by using special display techniques (for example, graphic overlay).

The Figure also shows measuring means 13 for measuring the respiratory activity. Measuring means of this kind are known from other medical imaging techniques, such as computed tomography and magnetic resonance imaging, and serve to ensure that successive images are formed in the same phase of the respiration so that errors due to motion are avoided in the reconstruction. These means can be used in a similar way in the present case, in conjunction with the triggering on the basis of the ECG, or for the control of the image processing unit 8 so as to correct for respiratory motion during the previously mentioned temporal integration of successive images, thus preventing a loss of sharpness of moving details.

After having read the foregoing, an expert in the present technical field will be readily capable of conceiving a computer program for executing the method in accordance with the invention.

Summarizing, it may be stated that the invention provides a method of forming X-ray images of high image quality of all parts of the body of a living being which move together with the heart, the applied amount of X-rays nevertheless remaining the same or being reduced even. For the sake of simplicity, in the context of the present patent application the term “cardiovascular system” is used to indicate the relevant parts moving together with the heart.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A method of enhancing the image quality of images of the cardiovascular system of a living being, which images are formed by means of an X-ray device which includes a generator for issuing pulses at a given rate in order to form successive images, which method includes the following steps:
a) measuring the activity of the heart of the living being,
b) controlling the generator on the basis of the heart activity,
c) adjusting the desired number of images per heart beat,
d) calculating an instant for issuing a pulse on the basis of the heart activity as measured in the step a) and the number of images per heart beat as adjusted in the step c),
e) determining an amount of X-ray dose per pulse, and
f) controlling the generator on the basis of the pulse issue instant as calculated in the step d) and the amount of the X-ray dose as determined in the step e).

2. A method as claimed in claim 1, wherein the desired number of images is adjusted to one image per heart beat.

3. A method as claimed in claim 2, in which the instant for issuing an X-ray pulse lies in the end-diastolic phase of the heart beat.

4. A method as claimed in claim 1 wherein the amount of the X-ray dose per pulse is inversely related to the number of images per heart beat as adjusted in the step c).

5. A medical imaging device comprising:
an X-ray source for issuing pulses at a given pulse rate and at a given dose through an examination region for the formation of successive images of a subject disposed within the examination region;
an X-ray detector disposed across the examination region from the X-ray source for receiving the issued pulses;
measuring means for measuring activity of the heart of the subject;
pulse rate means for adjusting the pulse rate of the X-ray source based on the activity of the heart of the subject;
timing means for calculating a plurality of instants per heart beat for issuing pulses on the basis of the heart activity; and
dosage means for adjusting the amount of X-ray dose per pulse; and
a control unit for controlling the X-ray source on the basis of the adjusted pulse rate, the plurality of instants, and the amount of X-ray dose per pulse.

6. A medical imaging device as claimed in claim 5, wherein the measuring means includes ECG recording equipment for measuring the myocardic activity during a cardiac cycle.

7. A medical imaging device as claimed in claim 5, wherein the pulse rate of the X-ray source is adjusted to one pulse per heart beat.

8. A medical imaging device as claimed in claim 5, wherein the timing means are arranged to calculate the instants for issuing the pulses relative to a given fixed point in the electrocardiogram.

9. A device as claimed in claim 8, wherein the dosage means for determining the amount of the X-ray dose per pulse is arranged to distribute a given permissible dose per heart beat among the plurality of instants per heart beat for issuing pulses.

10. A program storage device readable by a machine, tangibly embodying a program of instructions executable by the machine to perform method steps for controlling a medical imaging device having an X-ray source, the method steps comprising:
a) measuring the activity of the heart of a living being,
b) adjusting a desired number of pulses of the X-ray source per heart beat,
c) calculating instants for issuing the pulses on the basis of the heart activity as measured in the step a) for the number of pulses per heart beat as adjusted in the step b),
d) determining an amount of X-ray dose per pulse, and
e) controlling the X-ray source on the basis of the pulse issue instants as calculated in the step c) and the amount of the X-ray dose as determined in the step d).

11. A program storage device as claimed in claim 10, wherein the desired number of pulses is adjusted to one pulse per heart beat, each pulse corresponding to a resulting image of at least a portion of the living being.

12. A program storage device as claimed in claim 11, wherein the instant for issuing an X-ray pulse lies in the end-diastolic phase of the heart beat.

13. A program storage device as claimed in claim 10 wherein the amount of the X-ray dose per pulse is inversely related to the number of pulses per heart beat as adjusted in the step b).
